(19) United States
(12) Patent Application Publication
(10) Pub. No.: US 2016/0314722 A1
(43) Pub. Date: Oct. 27, 2016

(54) MOISTURE EGRESS PROMOTING PIPE MARKER

(71) Applicant: Brian J. Cole, Cascade, WI (US)

(72) Inventor: Brian J. Cole, Cascade, WI (US)

(21) Appl. No.: 14/695,897

(22) Filed: Apr. 24, 2015

(51) Int. Cl. G09F 3/04; G09F 3/10

(52) U.S. Cl. CPC G09F 3/04; G09F 3/10

(57) ABSTRACT

A marker adapted to be wrapped around a pipe, the marker comprising a sheet, the sheet having a plurality of spaced apart dimples therein. The dimples are in rows, and each dimple is shaped like a part of a sphere and is staggered midway relative to the preceding row. The sheet is flexible and curved, and the sheet bears indicia.

### BACKGROUND

This disclosure is directed to a marker to be wrapped around a pipe. More particularly, this disclosure is directed to a pipe marker for a metal pipe.

In many industrial piping applications, is it is important that the piping indicate the purpose of a particular pipe, or the type of material passing through the pipe. The piping often has a particular color, and often displays text or text on the pipe to identify the purpose of the pipe or the type of material passing through the pipe.

In many instances, especially where steel piping is concerned, one way to add indicia to the piping, other than by hand painting on the piping, is to attach a placard of some kind to the pipe. An example of such a placard can be found in U.S. Pat. No. 4,246,712, which is incorporated herein by reference.

Another concern with piping in industrial applications is the possible failure of the pipe. One common cause of pipe failure is corrosion resulting from moisture contact with the pipe, either from condensation or from precipitation. it has been found that if a plastic pipe marker is wrapped around a steel pipe, the plastic pipe marker tends to hold moisture between the marker and the pipe. This significantly increases the rate of corrosion of the pipe under the marker. As a result, early pipe failure could occur. Because of this problem, plastic pipe markers are not commonly wrapped around steel piping.

There is therefore a need for a marker with appropriate indicia that can be wrapped around a pipe, that does not promote pipe moisture corrosion.

### SUMMARY

Disclosed is a marker adapted to be wrapped around a pipe, the marker comprising a sheet, the sheet having a plurality of spaced apart dimples therein. The sheet is flexible and curved, and the sheet bears indicia. The dimples are in rows, and each dimple is shaped like a part of a sphere and is staggered midway relative to the preceding row.

### BRIEF DESCRIPTION OF THE DRAWINGS

FIG. 1 is a perspective view of an end of a pipe with a pipe marker according to this disclosure wrapped around the pipe.

FIG. 2 is a top view of a pipe marker according to this disclosure.

FIG. 3 is a bottom view of a pipe marker according to this disclosure.

FIG. 4 is a top perspective view of a bottom portion of a form for creating indentations in the pipe marker of FIGS. 2 and 3.

FIG. 5 is a bottom perspective view of a top portion of the form for creating indentations in the pipe marker of FIGS. 2 and 3.

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward”, “downward”, “side”, “top” and “bottom”, etc., are words of convenience and are not to be construed as limiting terms.

### DESCRIPTION OF THE EMBODIMENT

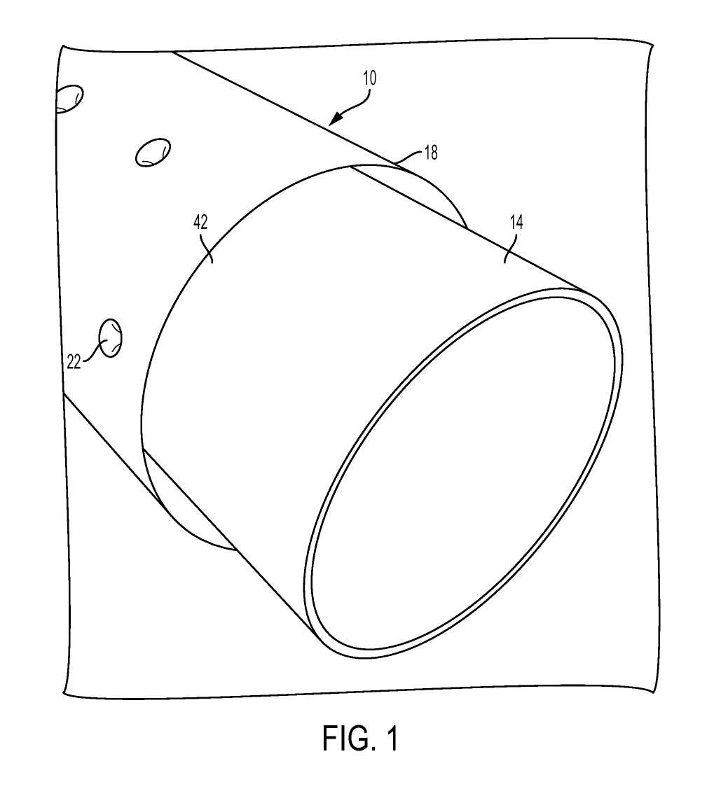

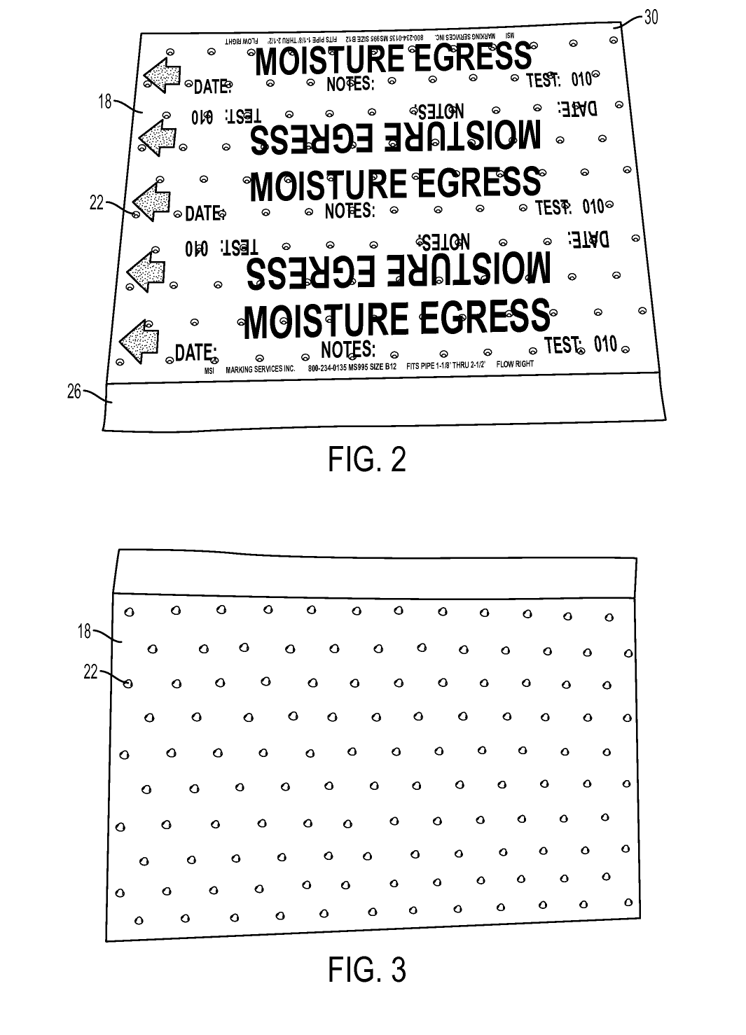

Illustrated in FIGS. 1 to 4 is a marker 10 adapted to be wrapped around a pipe 14, the marker 10 comprising a sheet 18, the sheet 18 having a plurality of spaced apart rows of spaced apart dimples 22 therein. The spaced apart dimples 22 cover substantial all of the sheet 18.

Dimple as used herein means an impression or indentation into a surface, the indentation not being a through hole. Pipe markers having through holes therein have been found to encourage moisture to remain in the holes, thus increasing the amount of moisture adjacent the pipe, and thus increasing the rate of corrosion of metal pipe.

In the preferred embodiment, each of the dimples 22 is rounded, and more particularly shaped like a part of a sphere, between 1/16 and ¼ inch in diameter, and more preferably ⅛th inch in diameter, and between 1/32 and ¼ inch deep, or more preferably 1/16th inch deep, but in other embodiments (not shown), other dimple shapes can be used.

Each of the dimples 22 is spaced apart with sufficient space to hold the marker away from the pipe, but preferably spaced apart from one another horizontally by about one inch, and vertically about ⅞s of an inch. in other embodiments (not shown), other dimple spacing can be used. The dimples 22 in each row of dimples 22 is staggered midway relative to its preceding row, but in other less preferred embodiments (not shown), each row could be identical or have varied spacing or other dimple patterns.

In the illustrated embodiment, the sheet 18 is flexible, being made of a 3 to 7 mill, but preferably 5 mill polymer, and the sheet 18 is curved to aid in the bending of the marker 10 around an annular pipe 14. The top layer of the sheet is covered by a 1 mill layer of ultraviolet protecting plastic, and indicia added to the pipe marker is placed between the polyester layer and the UV plastic.

To aid in the application of the pipe marker 10 to the pipe 14, the sheet 18 has an adhesive strip 26 along one edge thereof, so that the one edge can be adhered to an opposite edge 30 of the sheet 18 once the sheet 18 has been wrapped around a pipe 14. More particularly, the adhesive strip 26 is shipped with a removal protective cover to prevent the accidental adhering of the strip prior to the application of the pipe marker 10 to a pipe 14.

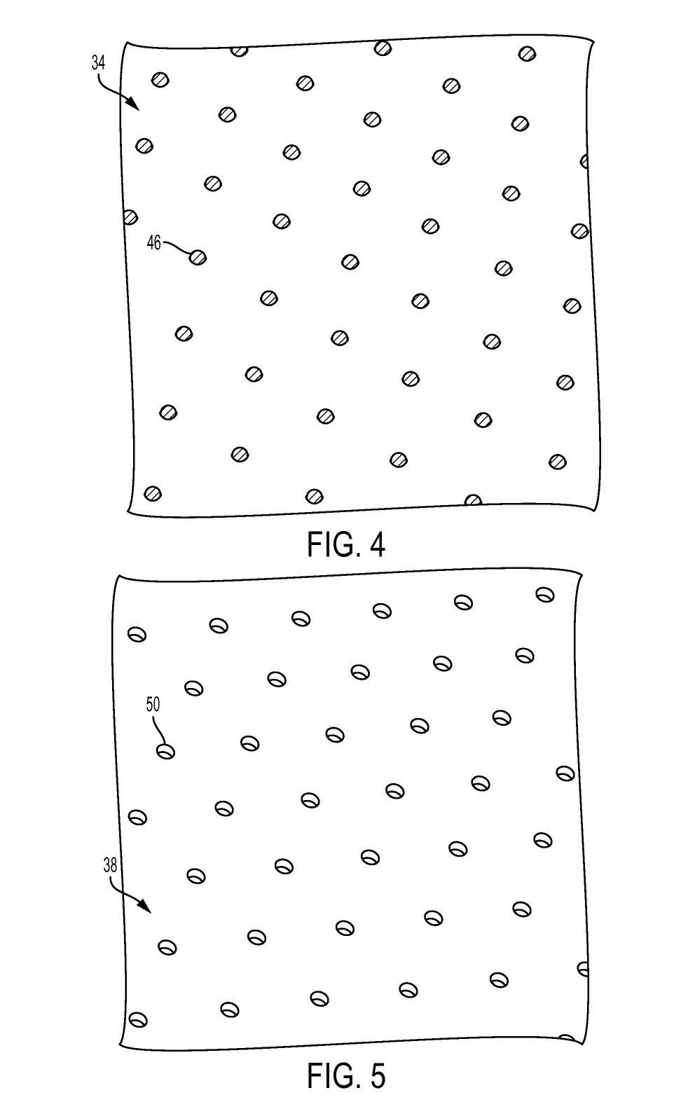

To manufacture the pipe marker 10 of this disclosure, a preferred method is to take a flat marker, and then to modify it in a form to have the desired dimple pattern therein. One method of creating such a form is illustrated in FIGS. 4 and 5. FIG. 4 is a top perspective view of a bottom portion 34 of a form for creating dimples in the pipe marker, and FIG. 5 is a bottom perspective view of a top portion 38 of the form for creating dimples in the pipe marker. The bottom portion 34 has a plurality of spaced apart balls 46 pressed into a surface, and the top portion has a plurality of spaced openings 50 therein that correspond to the locations of the balls 46. A flat pipe marker is placed between the bottom and top portions of the form, and the form portions are pressed together to place the dimples in the pipe marker. The flat dimpled pipe marker 10 is then curved by placing the marker around a heated drum. In a high production manufacturing process (not shown), the flat form portions of FIGS. 4 and 5 would be replaced with two rolls of similar form portions, with flat markers passing through the nip between the rods in order to place the dimples in the pipe markers.

By dimpling a plastic marker, an air space is introduced between the marker and the pipe, allowing air to circulate under the marker and allowing moisture in this area to escape. This reduces the likelihood of the premature failure of the piping beneath the wrap-around pipe marker. The dimples 22 act as legs or standoffs, providing a means for spacing the remainder of the marker from the pipe. This allows moisture between the marker and the pipe to runoff or evaporate. And with the partial sphere construction of the dimples, only a point contact is made between the dimple 22 and the pipe 14, reducing the likelihood of moisture being trapped between the dimple 22 and the pipe 14.

The pipe marker 10 of this disclosure has been found to reduce the corrosion of horizontal piping, by both promoting moisture egress from between the marker and the pipe, while at the same time limiting the amount of precipitation that can reach the pipe. With vertical piping, generally no more corrosion occurs than occurs on the adjacent portion of the pipe not under the marker.

The pipe marker of this disclosure is especially useful to any customer who requires marking of steel piping where moisture is present. This may include outdoors as well as high humidity environments and areas where condensation is present.

Various other features of this disclosure are set forth in the following claims.

1. A marker adapted to be wrapped around a pipe, the marker comprising a sheet, the sheet having a plurality of spaced apart rounded dimples therein over substantially the entire sheet, the rounded dimples being adapted to extend towards the pipe, wherein each of the dimples is between 1/32 and ¼ inch deep, and wherein the sheet is between 4 and 8 mills thick.

2. The marker according to claim 1 wherein each of the dimples is between 1/16 and ¼ inch in diameter.

3. (canceled)

4. The marker according to claim 1 wherein each of the dimples is spaced apart from one another horizontally by about one inch, and vertically about ⅞s of an inch.

5. The marker according to claim 1 wherein each row of dimples has dimples that are staggered relative to the preceding row.

6. The marker according to claim 1 wherein each row of dimples has dimples that are staggered midway relative to the preceding row.

7. The marker according to claim 1 wherein the sheet is flexible.

8. The marker according to claim 1 wherein the sheet is curved.

9. The marker according to claim 1 wherein the sheet has an adhesive strip along one edge thereof, so that the one edge can be adhered to an opposite edge of the sheet once the sheet has been wrapped around a pipe.

10. (canceled)

11. The marker according to claim 1 wherein the sheet includes a polymer layer and an ultraviolet protecting layer.

12. The marker according to claim 1 wherein the sheet bears indicia.

13. (canceled)

14. The marker according to claim 1 wherein each of the dimples is shaped like a part of a sphere.

15. The marker according to claim 1 wherein the marker is made of plastic.

16. (canceled)

17. (canceled)

18. The marker according to claim 1 wherein the sheet is flexible and curved, and the sheet bears indicia.

19. The marker according to claim 18 wherein with each row of dimples, the dimples are staggered midway relative to the preceding row.

20. The marker according to claim 18 wherein each of the dimples is shaped like a part of a sphere.

21. The marker according to claim 1 wherein at least one of the dimples is an indentation into the sheet, the indentation not being a through hole.

22. A pipe with a pipe marker comprising a pipe and a marker, the marker comprising a sheet, the sheet being wrapped around the pipe and having a plurality of spaced apart dimples therein over substantially the entire sheet, wherein each of the dimples is between 1/32 and ¼ inch deep, and wherein the sheet is between 4 and 8 mills thick, the dimples extending through and away from the sheet and between the sheet and the pipe.

23. A pipe with a pipe marker comprising a pipe and a marker, the marker comprising a sheet, the sheet being held spaced apart from the pipe so that there is an air space between the sheet and the pipe to allow air to circulate under the marker and allowing moisture in the air space to escape.
